(19) United States
(12) Patent Application Publication
(10) Pub. No.: US 2007/0113992 A1
(43) Pub. Date: May 24, 2007

(54) Blind arrangement for the window of a motor vehicle

(76) Inventors: Harald Kruger, Erlangen (DE); Thomas Pohl, Grossenseebach (DE)

Correspondence Address: CHRISTIE, PARKER & HALE, LLP, PO BOX 7068, PASADENA, CA, 91109-7068, US

(21) Appl. No.: 10/566,025

(22) PCT Filed: Jul. 14, 2004
(86) PCT No.: PCT/DE04/01585

§ 371 Date: Jan. 24, 2006

(30) Foreign Application Priority Data
Jul. 25, 2003 (DE) 10334695.3

(51) Int. Cl. B60J 1/20

(52) U.S. Cl. 160/370.22

(57) ABSTRACT

A blind arrangement for the window of a motor vehicle comprising a blind that can be wound onto a winding element and wound off the winding element such that it extends in front of the window, two long guiding rails that are interspaced transversally in relation to the extension direction thereof and extend on both sides of the blind, and two sliders that are arranged in one of the two long guiding rails in a longitudinally displaceable manner and are used to guide the blind during the unwinding in such a way that it extends in front of the window after the unwinding. A lever element is mounted on each slider in an articulated, freely pivotable manner, said lever element also being connected to the blind.

### CROSS-REFERENCE TO A RELATED APPLICATION

This application is a National Phase Patent Application of International Application Number PCT/DE2004/001585, filed on Jul. 14, 2004, which claims priority of German Patent Application Number 103 34 695.3, filed on Jul. 25, 2003.

### BACKGROUND

The invention relates to a blind arrangement for the window of a motor vehicle. An arrangement of this kind comprises a blind which on the one hand can be wound up onto a winding element and which on the other hand can be unwound from the winding element so that it extends in front of the window and covers the window opening; two longitudinally extended guide rails which are spaced from each other transversely to their extension direction and extend either side of the blind; as well as two sliders which are each arranged longitudinally displaceable in one of the guide rails and by which the blind is guided when unwound along the two guide rails so that it extends in front of the window opening once unwound.

Since the window openings in motor vehicles are generally not rectangular but are more trapezoidal in shape the guide rails which are normally mounted on the two side frame parts of the window run inclined to each other. This means that during lifting and lowering (unwinding and winding) of the blind the distance between the side edges of the blind and the guide rails of the blind arrangement does vary.

The object of the invention is therefore to provide a connection between the blind and the slider which is guided in the guide rails which with a simple construction is characterised by sufficient flexibility so that any changes which may occur in the distance between the side edges of the blind and the associated guide rails as the blind is wound up and down can be compensated.

### BRIEF DESCRIPTION

According to this a lever element is mounted in articulated freely pivotal manner on each of the two sliders and is connected at its other end to the blind.

The solution according to the invention is characterised in that it requires neither automatic guidance nor a separate drive to move and guide the lever elements. Rather the lever elements need only on one side be attached in freely pivotal manner to each slider associated with the guide rail and connected to the blind on the other side. They do not have to stand in active connection with any further structural assemblies.

Despite this simple construction the solution according to the invention enables use with different shapes of window frames and different lengths of side frame parts. Through the freely pivotal action of the lever elements relative to the slider a flexible compensation of fluctuations in the distance between the guide rails and the relevant associated side edge of the blind is guaranteed.

The two lever elements are each connected at their end on the blind side to one of the two side edges of the blind running along the guide rails when the blind is closed (e.g. in the region of the upper end of the blind), namely preferably in the manner so that a cross bar is provided on the blind which extends transversely (i.e. perpendicular or at a slight angle inclined to the vertical) to the extension direction of the window pane, and which runs (preferably at the upper end of the blind) from one side edge to the other side edge of the blind. The lever elements are attached on each one of the two end sides of the cross bar whereby each of the two end sides of the cross bar lies on one of the two side edges of the blind.

The tensioning of the blind material (roller blind material) leads to a self-centring of the cross bar so that no length compensation is required in the direction of the winding axis (longitudinal axis of the winding element).

The connection of the lever elements to the blind must be sufficiently flexible (particularly through the cross bar provided on the blind) in order to permit a swivel movement of the lever elements relative to the sliders guided in the guide rails. For this the lever elements are each connected by their end remote from the guide rail and associated with the blind to the blind with articulated movement, namely in particular through a structural assembly, such as e.g. the cross bar described above, which is mounted on the blind and has a more stable shape than the material of the blind.

Suitable means for connecting the lever elements to the blind with articulated movement are for example a hinge, more particularly in the form of a rotational joint or a film hinge, elastic means, more particularly in the form of a spring element, as well as an elastic transition area moulded in one piece and extending from the cross bar to the lever element.

For increased flexibility the lever element can itself be formed elastic or in several parts whereby the individual parts of the lever element are each connected to each other through a hinge (film hinge). In order to restrict the swivel movement and thus the possible angular positions of the lever elements relative to the guide rail associated stops can be provided on the lever element on the one hand and on the blind on the other whereby the stop on the blind side is formed in particular through the structural assembly (e.g. in the form of a cross bar) through which the relevant lever element is connected to the blind.

The lever elements are furthermore preferably designed curved so that when the blind is closed and covers the window opening they run along a curved section of the window frame, more particularly both along a side frame part and also along the upper frame part which defines the window opening at the top. This enables a complete covering of the window opening (window surface) in the case of windows which in the upper area have a curved transition from the side frame parts into the upper frame part which restricts the window opening at the top.

Depending on whether the window frame is formed identical or different in the region of the front side frame part and in the region of the rear side frame part the two lever elements are designed with identical or different curvature whereby the curvature is adapted each time to the transition region between the associated side frame part and the upper frame part of the window frame. By associated side frame part is thereby meant that frame part on which the guide rail is mounted in which the relevant lever element is guided through a slider.

The winding element can be formed in a simple way as a rotatable winding roller which is extended lengthwise substantially transversely to the extension direction of the guide rails.

The blind arrangement according to the invention is particularly suitable for use in those blinds which in the wound state are mounted underneath the window opening and which on unwinding from the winding element mounted underneath the window opening are moved upwards along the guide rails.

### BRIEF DESCRIPTION OF THE DRAWINGS

Further features and advantages of the invention will now be explained in the following description with reference to the embodiments illustrated in the drawings.

FIG. 1 is a side view of a window frame of a motor vehicle window defining a window opening with a winding roller for a blind.

FIG. 2a shows the window of FIG. 2 with a blind wound onto the winding roller.

FIG. 2b shows the arrangement of FIG. 2a with a half-wound blind which partially covers the window opening.

FIG. 2c shows the arrangement of FIG. 2a with a fully unwound blind covering the window opening.

FIG. 2d is a cross-section through a guide rail of the blind arrangement of FIGS. 2a to 2c.

FIG. 3a is a modification of the arrangement of FIGS. 2a to 2c with a wound-up, partially unwound and fully unwound blind.

FIG. 3b is a modification of the arrangement of FIGS. 2a to 2c with a wound-up, partially unwound and fully unwound blind.

FIG. 3c is a modification of the arrangement of FIGS. 2a to 2c with a wound-up, partially unwound and fully unwound blind.

FIG. 4 is a second modification of the arrangement of FIGS. 2a to 2c with a partially unwound blind.

FIG. 5 is a third modification of the arrangement of FIGS. 2a to 2c with a partially unwound blind.

FIG. 6 is a fourth modification of the arrangement of FIGS. 2a to 2c with a partially unwound blind.

FIG. 7 is a fifth modification of the arrangement of FIGS. 2a to 2c with a partially unwound blind.

### DETAILED DESCRIPTION

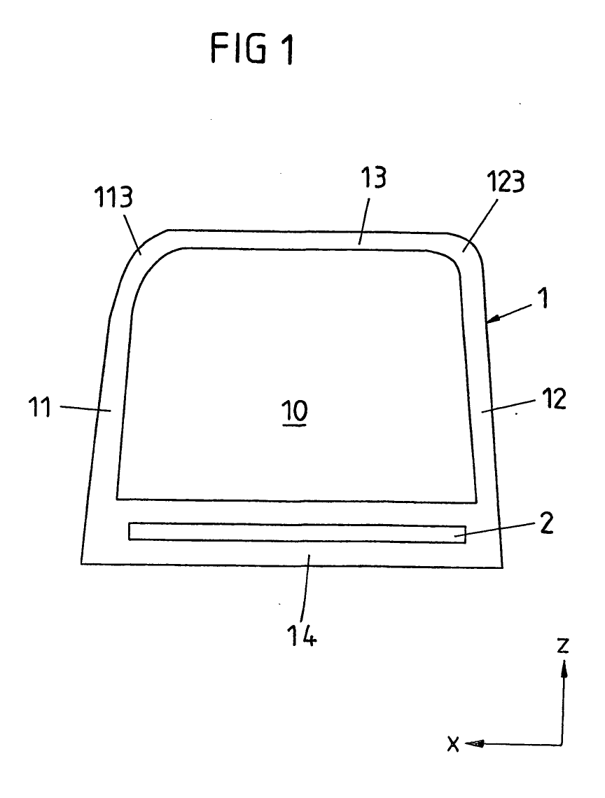

FIG. 1 shows a window frame 1 (made in one piece or of several elements) of a motor vehicle door in a motor vehicle which surrounds a window opening 10 with a front and rear frame part 11,12 as well as an upper and lower frame part 13,14.

The front and rear frame part 11, 12 thereby each extend slightly inclined relative to each other substantially along the vertical vehicle axis z ( in relation to the position of the vehicle door installed in the motor vehicle) and the upper and lower frame parts 13, 14 each extend substantially along the vehicle longitudinal axis x (driving direction) and define the window opening 10 at the top and bottom whilst the front and rear frame parts 11, 12 define the window opening 10 at the front and back. In the transition area 113 from the front side frame part 11 to the upper frame part 13 as well as in the transition area 123 from the rear side frame part 12 to the upper frame part 13 the window frame 1 is each time curved in shape.

On the lower frame part 14 underneath the window opening 10 there is a winding element 2 in the form of a winding roller on which the blind with which the window opening 1 can be covered can be wound up. The lower frame part 14 of the window frame 1 can form in particular a constituent part of the door ledge of a vehicle door.

As a result of the slight inclination of the side frame parts 11, 12 relative to each other the frame 1 as well as the window opening 10 are formed substantially trapezoidal each with rounded upper transition areas 113, 123 from the side frame parts 11, 12 into the upper frame part 13.

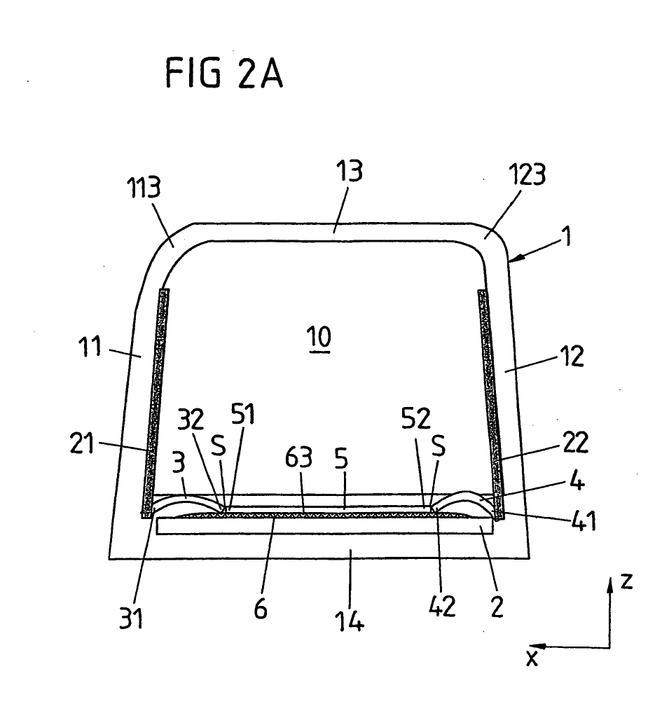

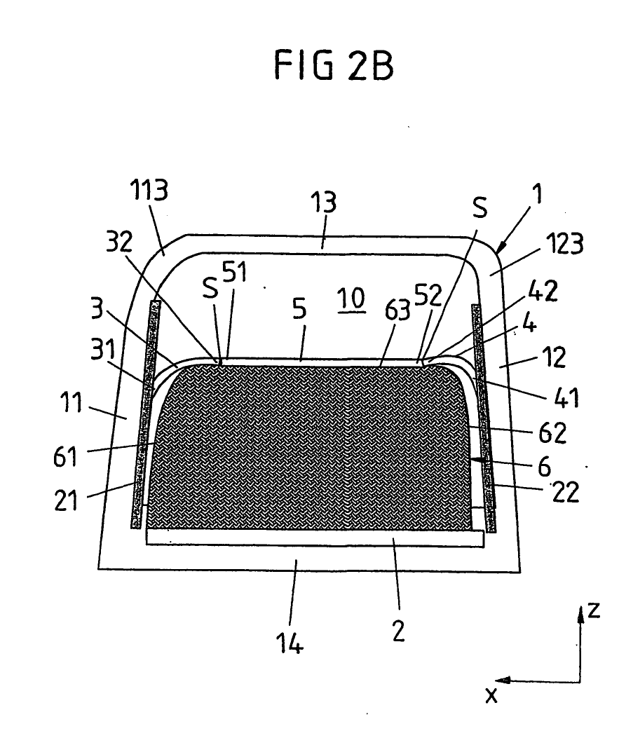

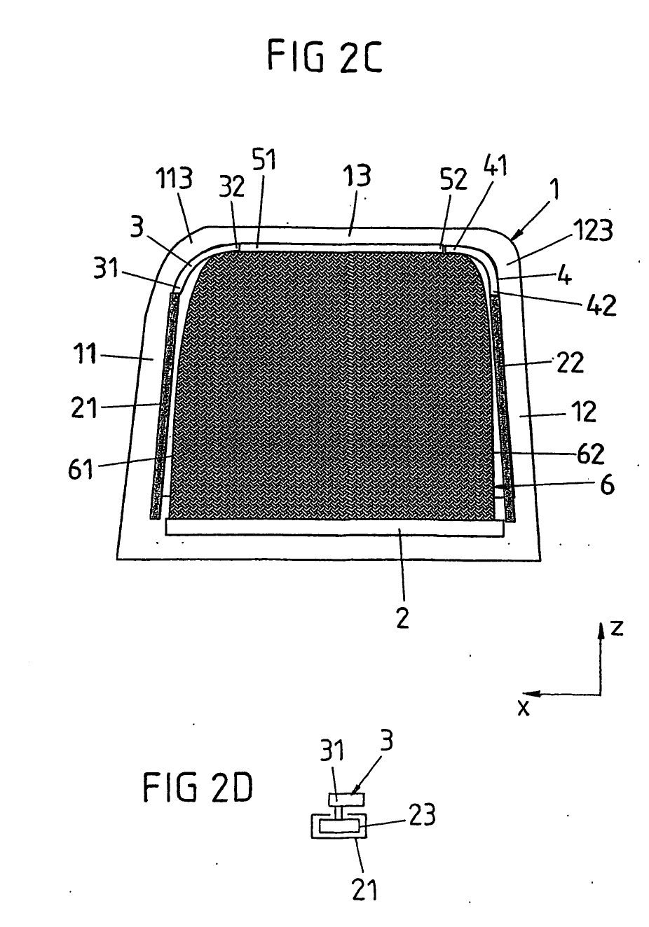

FIG. 2a shows the window frame of FIG. 1 with a blind 6 wound up onto the winding roller 2 and on whose upper edge 63 a cross bar 5 connected to the blind which consists of a flexible material (more particularly a woven fabric) extends substantially transversely to the front and rear side frame parts 11, 12 along the vehicle longitudinal axis x.

The two end sides 51, 52 (front and rear end side) of the cross bar 5 are each facing one of the two side frame parts 11, 12 and thereby each associated with a guide rail 21, 22 which extends along the front side frame part 11 and rear side frame part 12 parallel, and thus slightly inclined to the vertical vehicle axis z.

A slider is mounted displaceable in each of the two guide rails 21, 22 in the extension direction of the guide rail as can be seen from the cross-sectional view in FIG. 2d by way of example for the front guide rail 21 and the associated slider 23.

On each of the two sliders which are each mounted longitudinally displaceable in one of the two guide rails 21, 22 a lever element 3, 4 is connected for freely pivotal movement by a first end 31, 41. The corresponding lever element is connected for articulated movement by each other end 32 and 42 through a film hinge F to the relevant end side 51, 52 of the cross bar 5 of the blind 6. The two lever elements 3, 4 are thus each attached through the end sides 51, 52 of the cross bar 5 to one side edge 61, 62 of the blind 6 (see FIG. 2b) in the region of the upper end 63 of the blind 6.

If the drive of the roller arrangement, which is not shown in the drawings but is in active connection in known way with the winding roller 2, is actuated to unwind the blind from the winding roller 2 through rotation of the latter then the blind 6 which is connected through the lever elements 3, 4 to the sliders in the guide rails 21, 22 is raised as shown in FIGS. 2b and 2c.

It is clear from FIGS. 2a, 2b and 2c which show the blind 6 in the fully opened, partially closed and completely closed state (completely covering the window opening 10) that as a result of the slightly inclined arrangement of the guide rails 21, 22 to the vertical vehicle axis z the distance between the guide rails 21, 22 or the slider mounted in the relevant guide rail 21, 22 , and the connecting point S of the relevant lever element 3, 4 on the cross bar 5 of the blind 6 varies, namely decreases as the blind is wound down and up. This is compensated in that the lever elements 3, 4 during raising of the blind are pivoted about their relevant articulated joints relative to the associated slider and hereby change their angular position relative to the associated guide rail 21, 22, as can be seen from a comparison of FIGS. 2a, 2b and 2c. This pivotal movement of the lever elements 3, 4 about their articulated joints on the slider side is possible since the lever elements 3, 4 are each likewise attached at their blind-side ends for articulated movement to the blind, more accurately to the relevant end side 51, 52 of the cross bar 5.

FIG. 2c shows finally in addition that in the fully closed state of the blind 6 the lever elements 3, 4 each bear against the transition regions 113, 123 between the front and rear side frame part 11, 12 and the upper frame part 13 and are designed in their curvature so that the curvature of the relevant lever element 3, 4 corresponds to the curvature of the associated transition area 113 and 123. The two lever elements 3, 4 thereby also have a different curvature and length corresponding to the different curvature and length of the transition regions 113, 123.

The length of the guide rails 21, 22 can hereby be restricted to a minimum since in the fully closed position of the blind the lever elements 3, 4 form so to speak the extension of the relevant guide rail 21, 22 and extend in the vertical direction z along the remaining extent of the relevant side frame part 11, 12 and change into the region of the upper frame part 13.

To lift the blind along the guide rails 21, 22 as explained previously with reference to FIGS. 2a to 2c can be used for example riser cables or traction means mounted in or on the guide rails 21, 22 (as constituent parts of a cable pulley system) which are actuated by a drive mounted on the corresponding vehicle door and are connected to the sliders 23, 24 which are guided in the guide rails 21, 22. As a drive is suitable for example a drive motor or a spring drive. The decisive feature is that a suitable drive is in active connection with the sliders in order to enable a displacement (lifting or lowering) of the blind.

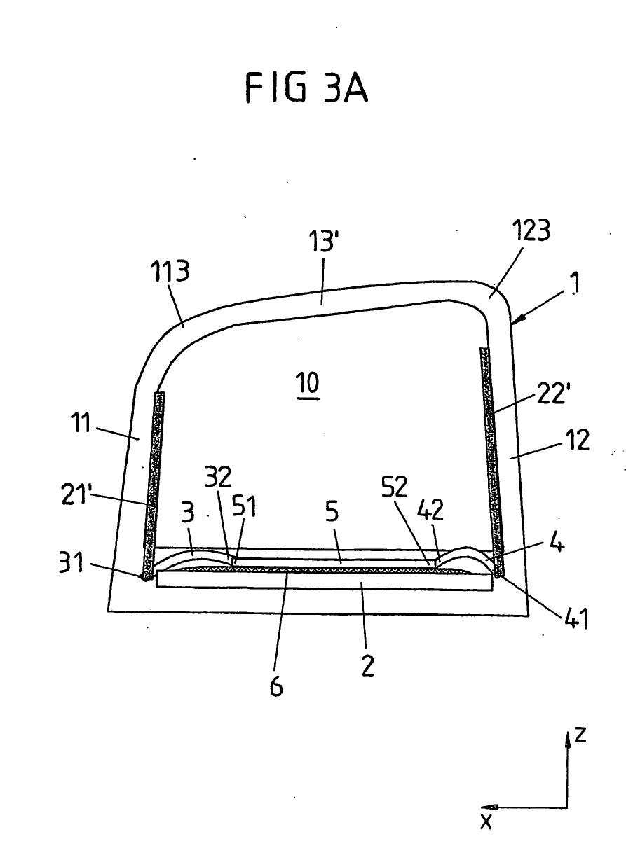

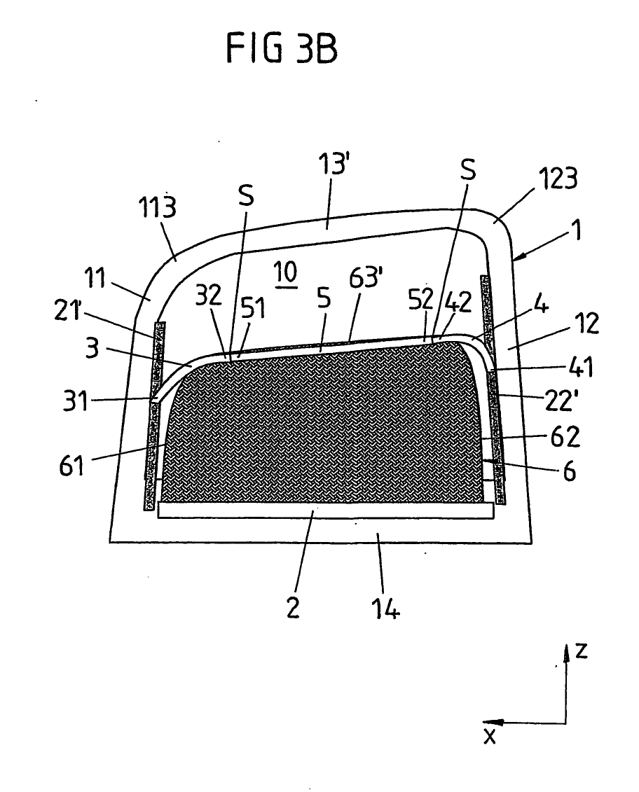

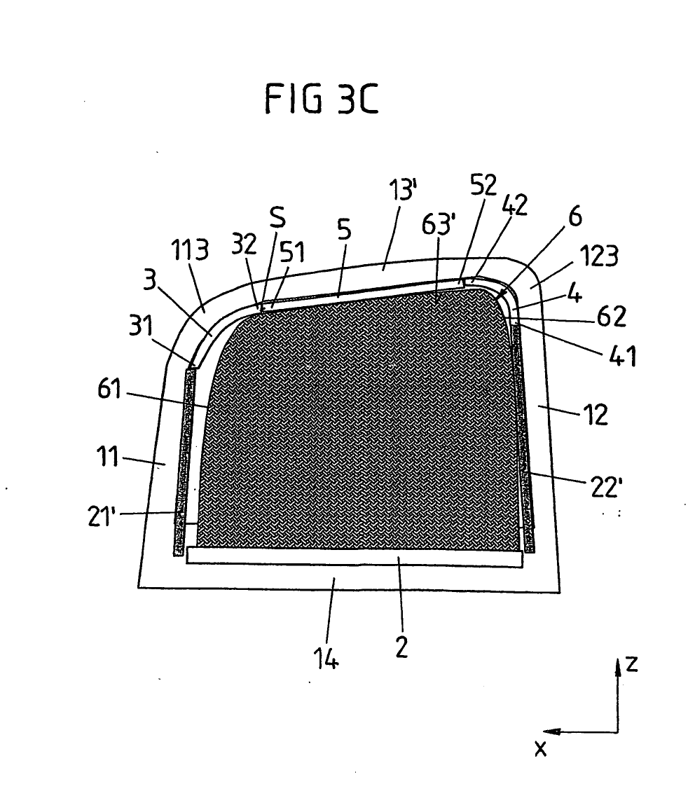

FIG. 3a to 3c show a modification of the blind arrangement illustrated in FIGS. 2a to 2c whereby in the position illustrated in FIG. 3a the blind 6 is wound completely up onto the winding roller 2, in the position illustrated in FIG. 3b the blind is partially unwound and the window opening 10 partially covered, and in the position illustrated in FIG. 3c the blind is completely unwound and completely covers the window opening.

The difference between the arrangement described with reference to FIGS. 2a to 2c and the arrangement illustrated in FIGS. 3a to 3c lies in the fact that according to FIGS. 3a to 3c the upper frame part 13′ of the window frame 1 is inclined to the vehicle longitudinal direction x, likewise the upper edge 63′ of the blind 6. Consequently the two guide rails 21′, 22′ have a different length along the vertical vehicle axis z and the two lever elements 3,4 are adapted to this modified geometry of the upper frame part 13′ and the upper edge 63′ of the blind 6 as well as the different length of the guide rail 21′, 22′. Thus with the arrangement illustrated in FIGS. 3a to 3c the difference between the two lever elements 3, 4 as regards length and curvature is greater than in the arrangement illustrated in FIGS. 2a to 2c. This is due to the fact that as a result of the inclined path of the upper frame part 13′ of the window frame 1 the two transition areas 113, 123 between the front and rear frame part 11, 12 and the upper frame part 13′ have greater deviations as regards curvature and length to which the lever elements 3, 4 are adapted in respect of their geometry (contouring) and length.

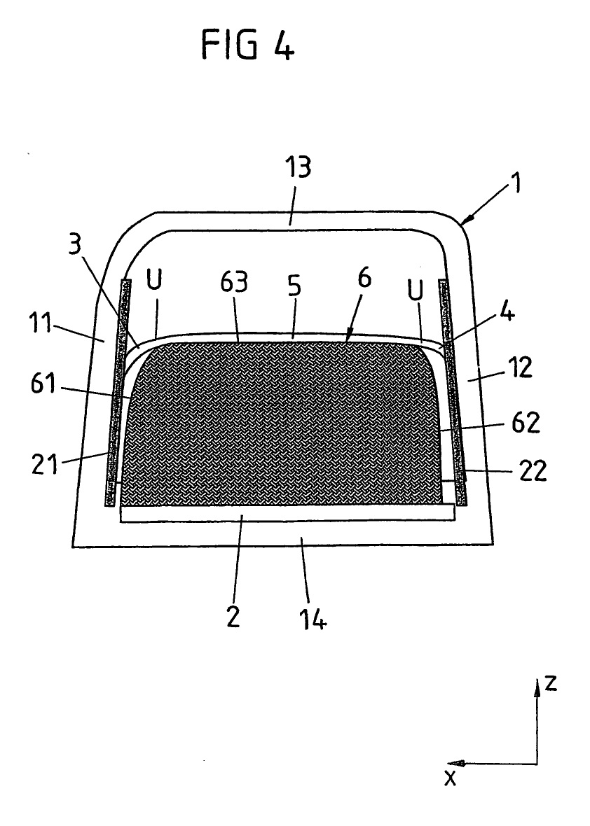

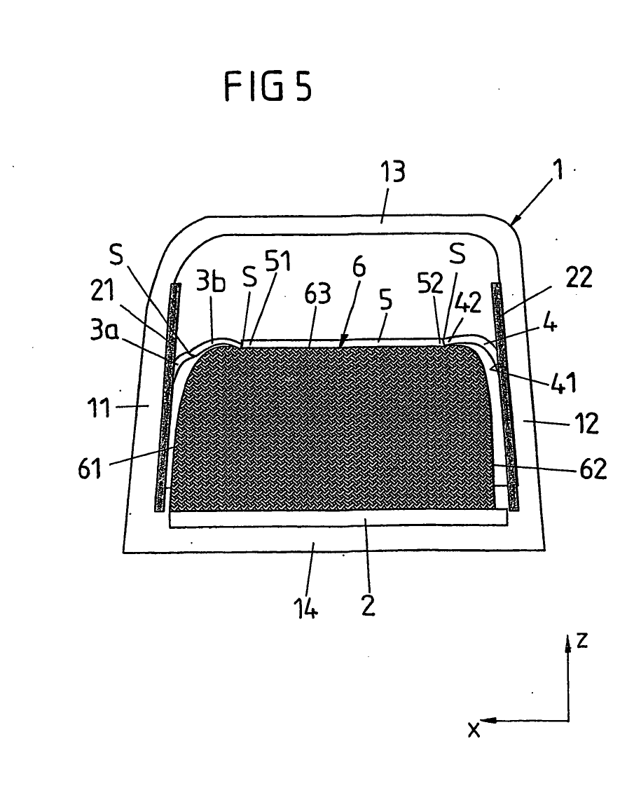

FIGS. 4 to 7 show different modifications of the blind arrangement previously illustrated, namely each with regard to the design of the lever elements 3, 4 and with regard to their connection to the two end sides 51, 52 of the cross bar 5 at the top edge 63 of the blind 6.

With the embodiment illustrated in FIG. 4 the lever elements 3, 4 are each connected integral with the cross bar 5, i.e. are each moulded in one piece with same. For this at least the transition region between the relevant lever element 3, 4 and the cross bar 5 must be made sufficiently elastic in order to allow the lever elements 3, 4 to pivot about their relevant articulated joint on the slider side (or guide rail side). For this the transition regions U can be formed correspondingly thinner than the lever elements 3, 4 and the cross bar 5 and/or (during manufacture of the cross bar 5 together with the lever elements 3, 4 formed thereon in a multi-component injection moulding process) consist of a different plastics material than the lever elements 3, 4 themselves as well the cross bar 5.

With the embodiment illustrated in FIG. 5 the one (front) lever element 3a, 3b is formed multi-part (in two parts) and consists of a first lever part 3a connected for articulated movement to the slider in the associated guide rail 21, and a second lever part connected through a film hinge S for articulated movement to the associated end side 51 of the cross bar 5. The two lever parts 3a, 3b are in turn connected for articulated movement together through a film hinge S. An increased flexibility of the front lever element 3a, 3b is hereby reached. Alternatively the lever element could consist of a material of increased flexibility.

With the embodiment illustrated in FIG. 5 the two lever elements 3, 4 each have at their end 32, 42 on the cross bar side a stop 32a, 42a which interacts with an associated stop 51a, 52a on the relevant end side 51, 52 of the cross bar so that the lever elements 3, 4 are prevented from folding completely round (beyond the equilibrium angle), more particularly when the blind 6 is wound completely up onto the winding roller 2.

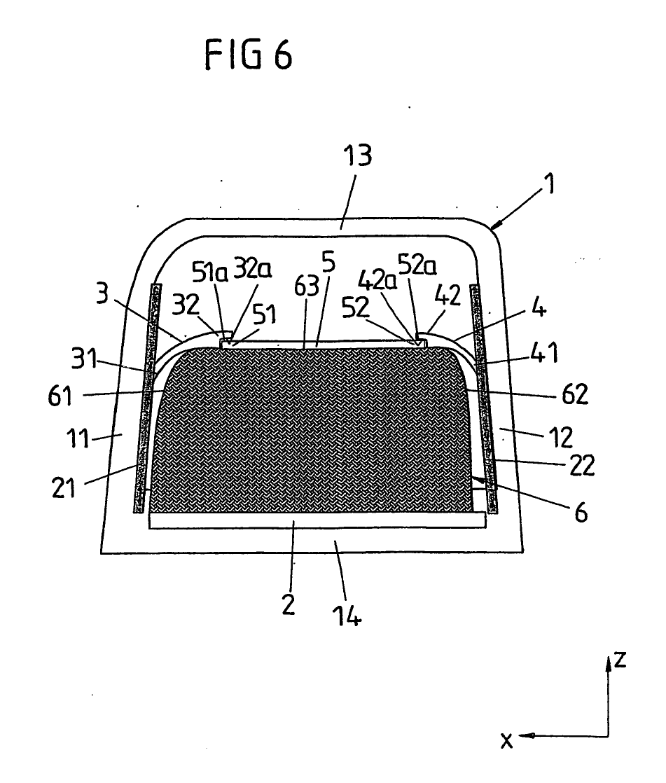

Thus with the blind arrangement illustrated in FIG. 6 the relevant lever element 3, 4 is indeed likewise attached freely on the relevant end side 51, 52 of the cross bar 5 but the maximum pivotal angle is however restricted by the associated stops 32a, 51a and 42a, 52a.

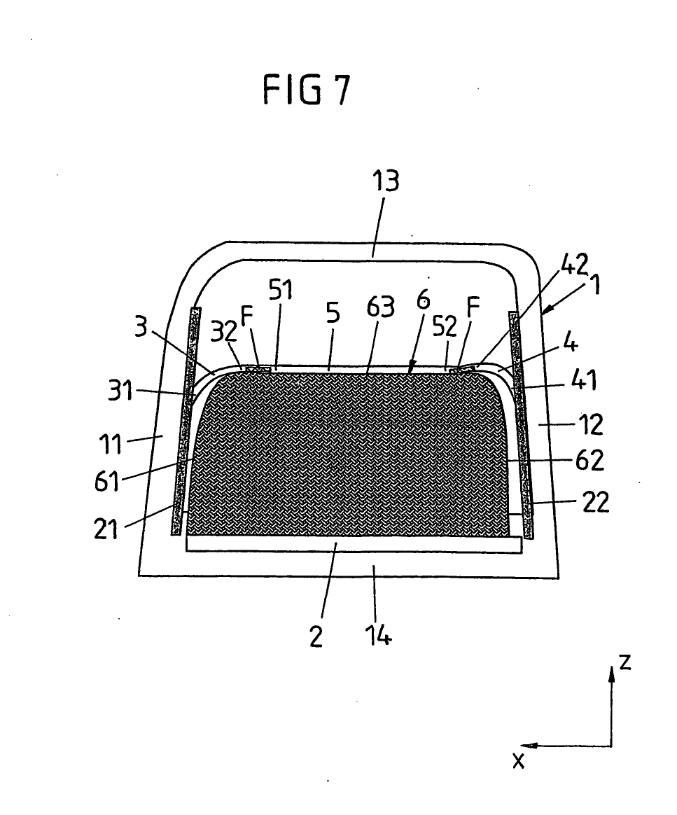

With the arrangement illustrated in FIG. 7 the lever elements 3, 4 are each connected through spring elastic elements F for articulated movement on the relevant associated end side 51, 52 of the cross bar 5.

Common to all the embodiments previously described is that the two lever elements 3, 4 are each connected for freely pivotal movement to the slider in the relevant associated guide rail 21, 22 and furthermore are connected for articulated movement to the blind 6 through the cross bar 5 so that the freely pivotal movement of the lever elements 3, 4 about their articulated joints on the guide rail sides is not impeded and the lever elements 3, 4 can freely change their angular position relative to the relevant guide rail 21, 22 so that as the blind 6 is raised and lowered (unwound and wound up) a variation in the distances between the relevant guide rail 11, 12 and the connection point (end side 51, 52) on the cross bar 5 can be compensated.

With all the embodiments no means are provided which cause an automatic guidance of the lever elements 3, 4 or influence their freely pivotal movement (apart from a restriction of the maximum swivel angle). Rather the relevant pivotal lever 3, 4 can during lifting or lowering of the blind be freely aligned in in its pivotal position so that the changing distance each time between the corresponding guide rail 21, 22 and the associated connection point on the blind 6 (end sides 51, 52 of the cross bar 5) is just bridged.

1-25. (canceled)

26. A blind arrangement for a window in a motor vehicle with
a blind which can on the one hand be wound onto a winding element and which can on the other hand be unwound from the winding element so that it extends across in front of the window
two elongated guide rails which are spaced from each other transversely to their extension direction and extend either side of the blind, and
two sliders which are each mounted longitudinally displaceable on one of the two longitudinally extended guide rails and by which the blind is guided as it is unwound so that once unwound it extends across in front of the window,
wherein
a lever element which is connected on one side to the blind is mounted in an articulated freely pivotal manner on each slider.

27. The blind arrangement according to claim 26, wherein a cross bar is provided on the blind and extends transversely to the extension direction of the guide rails whereby the lever element comprises two lever elements and are connected to the cross bar and the cross bar preferably runs along the upper edge of the blind.

28. The blind arrangement according to claim 26, wherein the lever elements are connected for articulated movement to the blind.

29. The blind arrangement according to claim 28, wherein the lever elements are connected to the blind through a hinge.

30. The blind arrangement according to claim 28, wherein the lever elements are each connected to the blind through a spring element.

31. The blind arrangement according to claim 27, wherein the lever elements are connected for articulated movement to the blind, and wherein the lever elements are connected in one piece to the cross bar through an elastic region.

32. The blind arrangement according to claim 26, wherein at least one lever element is formed one of elastic and multi-part.

33. The blind arrangement according to claim 32, wherein the parts of the multi part lever element are connected together through a hinge, more particularly in the form of a film hinge.

34. The blind arrangement according to claim 26, wherein stops are provided on the lever elements on one side and on the blind on the other side in order to define the maximum pivotal movement of the lever elements.

35. The blind arrangement according to claim 27, wherein stops are provided on the lever elements on one side and on the blind on the other side in order to define the maximum pivotal movement of the lever elements, and wherein the stop on the blind side is formed on the cross bar.

36. The blind arrangement according to claim 26, wherein the lever elements are formed curved.

37. The blind arrangement according to claim 36, wherein the lever elements are curved so that when the blind is closed and covers the window, the lever elements run along two frame parts of the window frame.

38. The blind arrangement according to claim 26, wherein the lever elements engage on the blind in the region of the upper edge thereof.

39. The blind arrangement according to claim 26, wherein the two lever elements are designed identical.

40. The blind arrangement according to claim 26, wherein the two lever elements are designed differently.

41. The blind arrangement according to claim 40, wherein the two lever elements have a different curvature and length.

42. The blind arrangement according to claim 26, wherein the guide rails are arranged on side frame parts of the window frame.

43. The blind arrangement according to claim 26, wherein the winding element is extended transversely to the extension direction of the guide rails.

44. The blind arrangement according to claim 26, wherein the winding element is rotatable in design and that the axis of rotation preferably runs transversely to the extension direction of the guide rails.

45. The blind arrangement according to claim 26, wherein the winding element is designed as winding roller.

46. The blind arrangement according to claim 26, wherein the blind in the wound up state lies underneath the window opening of the window.

47. The blind arrangement according to claim 26, wherein the upper edge of the blind is moved upwards during unwinding.

48. The blind arrangement according to claim 26, wherein the window has a substantially trapezoidal window opening defined by the geometry of the window frame.

49. The blind arrangement according to claim 26, wherein the two guide rails run inclined relative to each other.

50. The blind arrangement according to claim 26, wherein the pivotal movement of the lever elements during unwinding and winding up of the blind is determined through freely pivotal movement about the articulated joint on the slider side in dependence on the distance between the relevant guide rail and the associated attachment point on the blind.
